(19) United States
(12) Patent Application Publication
(10) Pub. No.: US 2025/0309673 A1
(43) Pub. Date: Oct. 2, 2025

(54) METHOD APPLIED TO ELECTRIC VEHICLE SUPPLY EQUIPMENT FOR MONITORING ELECTRIC VEHICLE BATTERY TEMPERATURE

(71) Applicant: NATIONAL TAIWAN UNIVERSITY, Taipei City (TW)

(72) Inventors: Yi-Yun LI, Douliu City (TW); Hung-Yu WEI, Taipei (TW)

(73) Assignee: NATIONAL TAIWAN UNIVERSITY, Taipei City (TW)

(21) Appl. No.: 18/742,479

(22) Filed: Jun. 13, 2024

(30) Foreign Application Priority Data
Mar. 28, 2024 (TW) 113111869

(51) Int. Cl. H02J 7/00; B60L 53/62; B60L 53/65; B60L 53/66; H01M 10/42; H01M 10/44; H01M 10/48

(52) U.S. Cl. CPC H02J 7/007194; B60L 53/62; B60L 53/65; B60L 53/66; H01M 10/425; H01M 10/443; H01M 10/486; B60L 2240/545; H01M 2010/4278; H01M 2220/20

(57) ABSTRACT

A method applied to an electric vehicle supply equipment (EVSE) for monitoring an electric vehicle (EV) battery temperature is disclosed. The method is performed by a supply equipment communication controller (SECC) of the EVSE. The SECC communicates with an electric vehicle communication controller (EVCC) of the EV and executes a dynamic control mode. The method has step (a): receiving battery specification information from the EVCC by the SECC; step (b): setting and storing multiple threshold temperatures according to the battery specification information by the SECC; step (c): receiving a present battery temperature from the EVCC during charging or discharging by the SECC; and step (d): determining, by the SECC, whether the present battery temperature is higher or lower than the threshold temperatures respectively, and accordingly modifying a charge schedule of the dynamic control mode by the SECC.

### CROSS REFERENCE TO RELATED APPLICATIONS

The present application claims priority to Taiwan application No. 113111869, filed on Mar. 28, 2024, the content of which is hereby incorporated by reference in its entirety.

### BACKGROUND OF THE INVENTION

### 1. Field of the Invention

The present application relates generally to a method for monitoring an electric vehicle battery temperature, and more particularly to a method applied to an electric vehicle supply equipment for monitoring an electric vehicle battery temperature.

### 2. Description of Related Art

A battery is the power source of the electric vehicle. Before the battery power is exhausted, the user can park the electric vehicle at a position next to an electric vehicle supply equipment (EVSE) and connect the charging adapter of the EVSE to the charge connecter of the electric vehicle for the EVSE to charge the electric vehicle. In general, the battery temperature of the electric vehicle will rise during the charging process. In a normal situation, the battery temperature will not exceed a specification-defined temperature range.

However, the battery temperature may exceed the specification-defined temperature range during the charging process, which means the battery temperature is higher than normal or too high. When the battery is still continuously being charged under the condition that the battery temperature is higher than normal or too high, the battery degradation is accelerated, and even serious accidents will happen. For example, the battery may burn or explode to damage the battery and the EVSE and injure people.

### SUMMARY OF THE INVENTION

An objective of the present application is to provide a method applied to an electric vehicle supply equipment for monitoring an electric vehicle battery temperature, for the purpose of preventing the damages caused by continuous charging and discharging under abnormal battery temperature.

The method of the present invention is performed by a supply equipment communication controller (SECC) of the EVSE. The SECC communicates with an electric vehicle communication controller (EVCC) of the EV and executes a dynamic control mode. The method of the present invention comprises: step (a): receiving battery specification information from the EVCC by the SECC; step (b): setting and storing multiple threshold temperatures according to the battery specification information by the SECC; step (c): receiving a present battery temperature from the EVCC during charging or discharging by the SECC; and step (d): determining, by the SECC, whether the present battery temperature is higher or lower than the threshold temperatures respectively, and accordingly modifying a charge schedule of the dynamic control mode by the SECC.

The method of the present invention is performed by the SECC of the electric vehicle supply equipment. Although the SECC is not directly connected to a battery management system of the electric vehicle, the SECC can still obtain the battery-related information of the electric vehicle via the EVCC. The battery-related information includes the battery type, the threshold temperatures, and the present battery temperature. Besides, the SECC can determine whether the present battery temperature is abnormal during the charging and discharging processes, and further modify the charge schedule of the dynamic control mode as long as the present battery temperature is determined as abnormal. For example, the SECC can control the electric vehicle supply equipment to stop charging the electric vehicle to prevent the damage caused by continuous charging under abnormal battery temperature and to increase the charging safety.

### BRIEF DESCRIPTION OF THE DRAWINGS

FIG. 1 is a block diagram of the electric vehicle supply equipment (EVSE) and the electric vehicle (EV) implementing the method of the present invention.

FIG. 2 is a flow chart of an embodiment of the method of the present invention.

FIG. 3A and FIG. 3B are detailed flow charts of STEP S4 of the method of the present invention.

FIG. 4 is a schematic diagram of the method of the present invention applied to ISO 15118-20 protocol.

FIG. 5A to FIG. 5D are other schematic diagrams of the method of the present invention applied to ISO 15118-20 protocol.

### DETAILED DESCRIPTION OF PREFERRED EMBODIMENT(S)

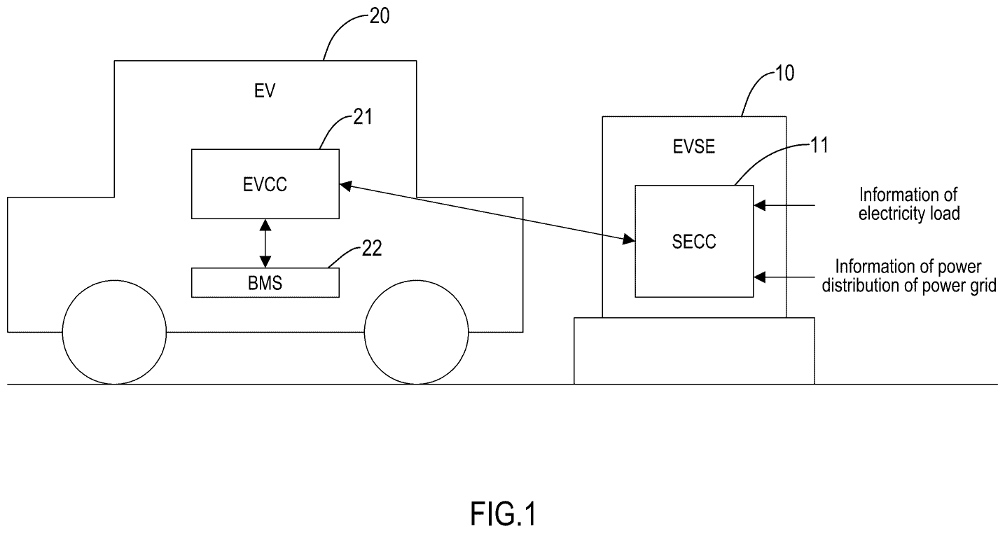

With reference to FIG. 1, the method applied to an electric vehicle supply equipment (EVSE 10) for monitoring an electric vehicle battery temperature is performed by a supply equipment communication controller (SECC 11) inside the EVSE 10. The SECC 11 wiredly or wirelessly communicates with an electric vehicle communication controller (EVCC 21) inside the electric vehicle (EV 20) for bidirectional data transmission and related controls. The EVCC 21 also communicates with a battery management system (BMS 22) of the EV 20 for bidirectional data transmission and related controls. As mentioned above, the SECC 11 and the EVCC 21 may communicate with each other via a vehicle-to-grid (V2G) communication interface. Besides, the method of the present invention may be applied to ISO 15118-20 protocol as example, so the SECC 11 and the EVCC 21 may perform their communication according to ISO 15118-20 protocol, but it is not limited to ISO 15118-20 protocol. A usage scenario as an example is described as follows. When a user parks the EV 20 at a position next to the EVSE 10, the user may connect a charging adapter of the EVSE 10 to a charge connecter of the EV 20. At that time, a communication interface inside the charging adapter of the EVSE 10 is connected to a communication interface inside the charging connector of the EV 20. Hence, the SECC 11 and the EVCC 21 can communicate with each other.

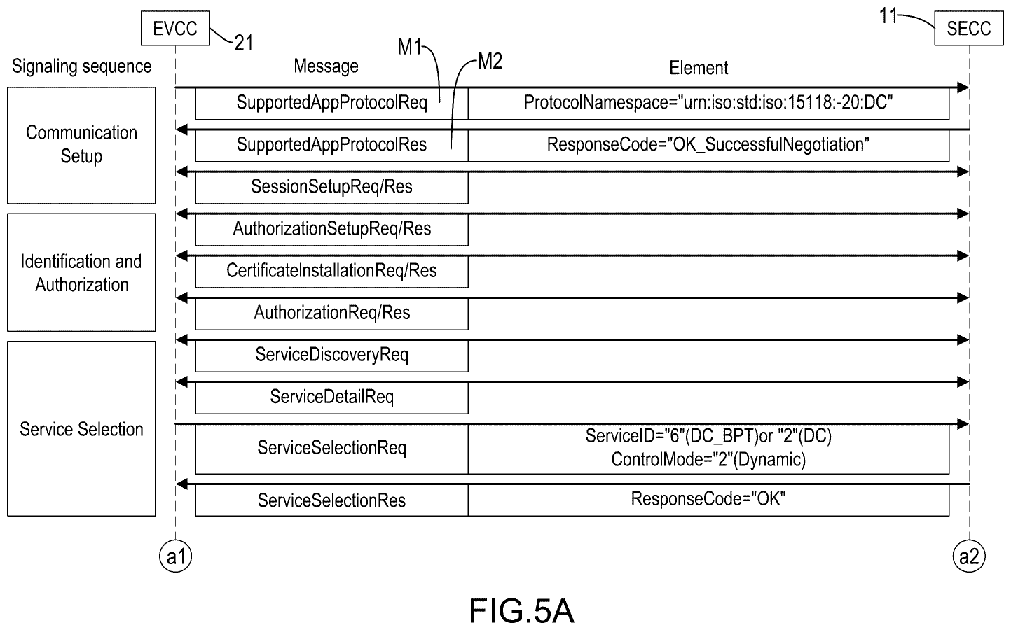

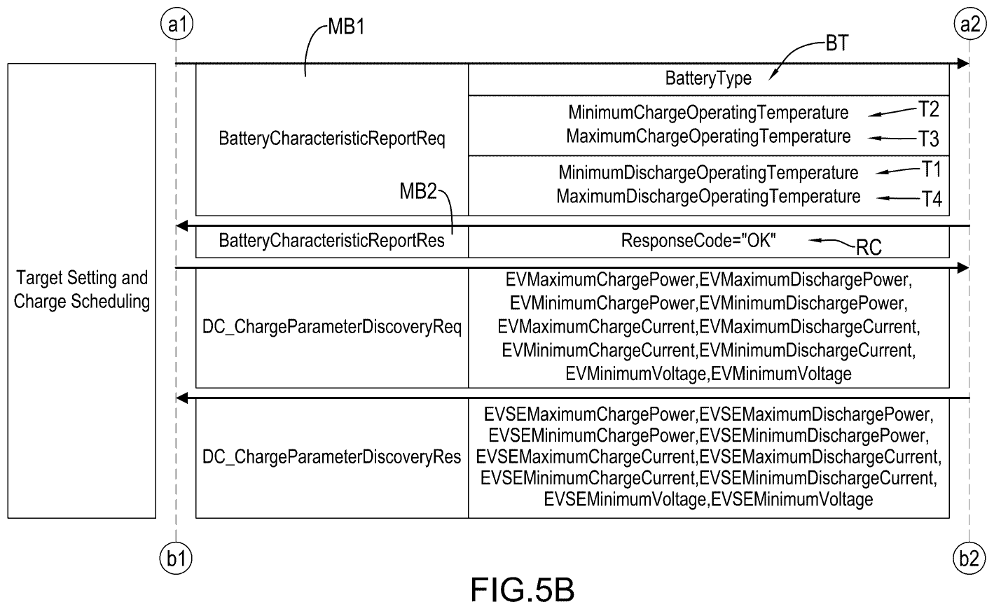

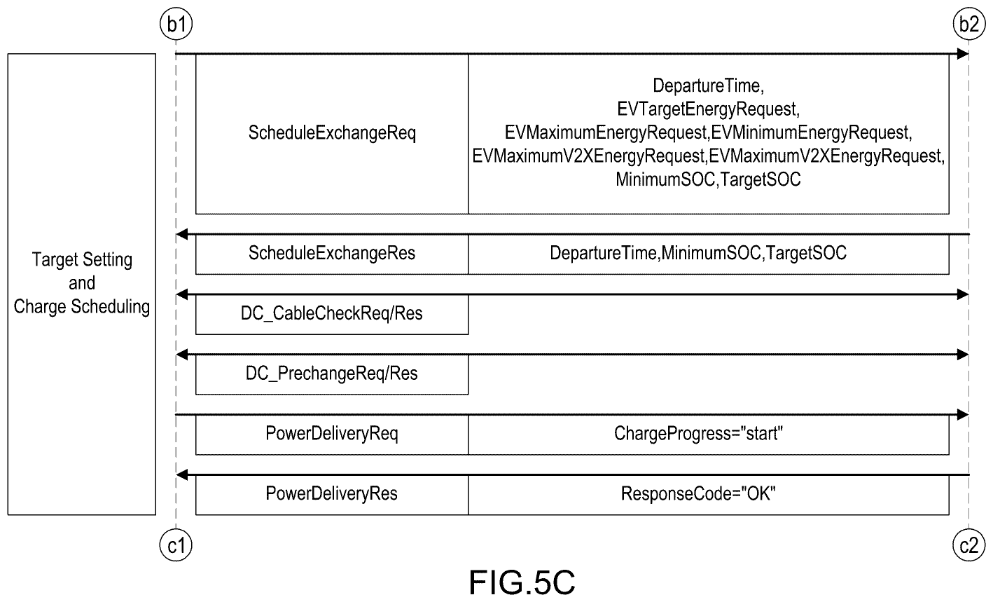

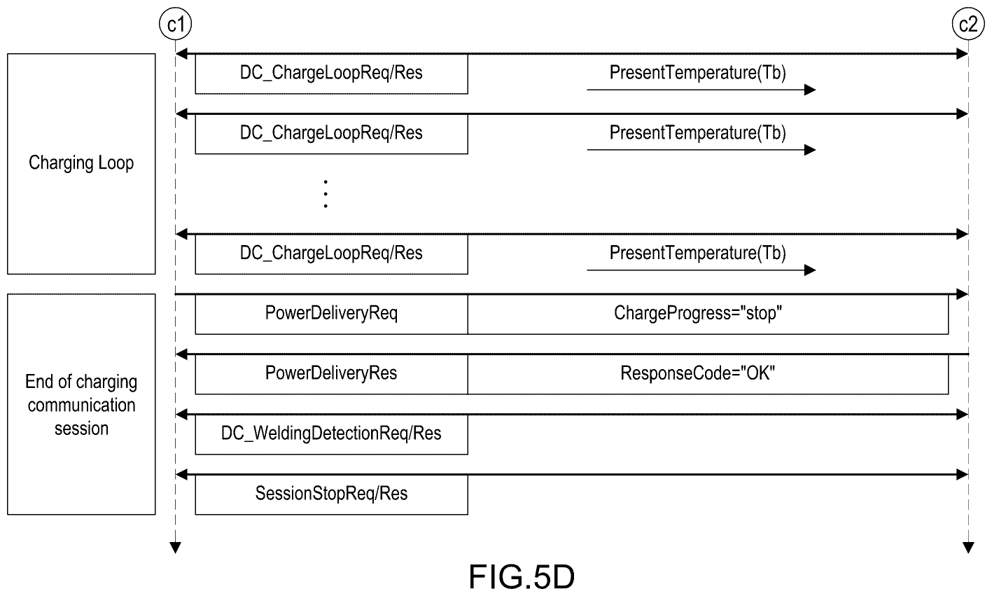

In an embodiment of the present invention, the SECC 11 of the EVSE 10 runs a dynamic control mode. For example, ISO 15118-20 defines the foregoing dynamic control mode and a scheduled control mode. The EVCC 21 is preset to automatically select and execute the dynamic control mode in the phase “Service Selection” defined by ISO 15118-20 as shown in FIG. 5A, and transmits a selection message of the dynamic control mode to the SECC 11 of the EVSE 10. Then, the SECC 11 can execute the dynamic control mode. With reference to FIG. 1, when the SECC 11 runs the dynamic control mode, the SECC 11 can dynamically control the charging or discharging state for the EV 20 according to information including the electricity load and the generated power in the nearby grid.

The dynamic control mode includes a charge schedule and defines a charging state, a discharging state, and a non-charging/discharging state in the charge schedule. The charging state is that the EVSE 10 is in the process of charging the EV 20. The discharging state is that the EVSE 10 is in the process of receiving the electricity discharged from the EV 20. The non-charging/discharging state is any state other than the charging state and the discharging state, so the EVSE 10 is not in the processes of charging the EV 20 and receiving the electricity discharged from the EV 20. For example, “Standby” or “Pause” defined by ISO 15118-20 can bring the EVCC 21 of the EV 20, which is not discharging or not being charged, to a rest in communication. When the SECC 11 runs the dynamic control mode, the SECC 11 controls the EV 20 to be in the charging state, the discharging state, or the non-charging/discharging state according to the charge schedule.

As mentioned above, the device in the present invention to execute the dynamic control mode is the SECC 11 of the EVSE 10. However, the SECC 11 of the EVSE 10 is not directly connected to the BMS 22 of the EV 20, such that the SECC 11 of the EVSE 10 cannot directly read the battery information from the BMS 22, and cannot directly obtain the data including a present battery temperature of the EV 20 and a battery specification information of the EV 20. The present battery temperature of the EV 20 is considered as an important safety factor for the processes of charging and discharging. Hence, as described as follows, the SECC 11 of the EVSE 10 has to obtain the battery-related information of the EV 20 and accordingly controls the charge schedule of the dynamic control mode.

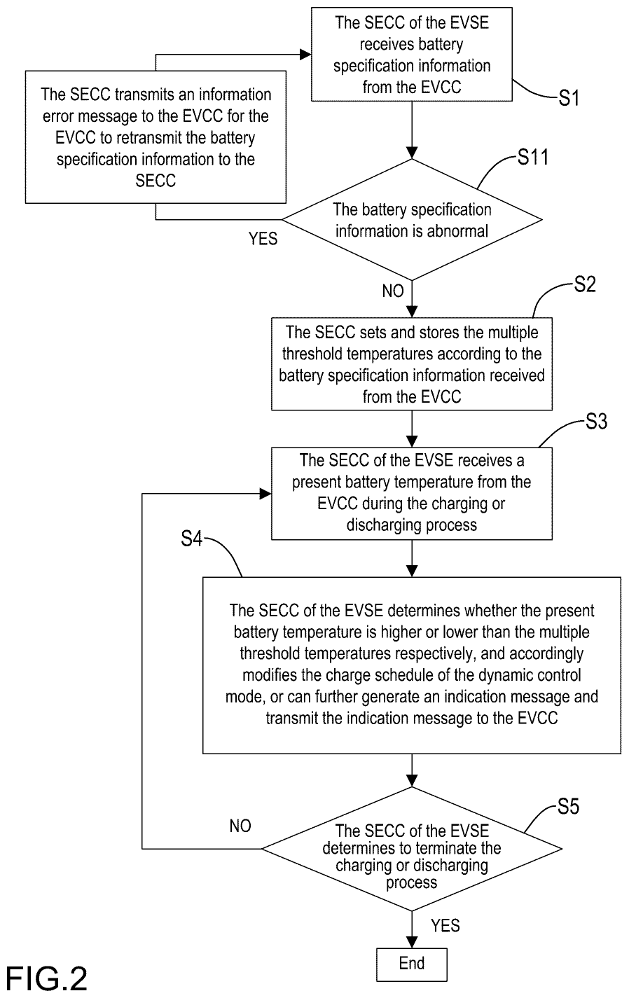

With reference to FIG. 1 and FIG. 2, the method applied to the EVSE 10 for monitoring the EV's battery temperature of the present invention is performed by the SECC 11 of the EVSE 10 and comprises the following steps:

STEP S1: The SECC 11 of the EVSE 10 receives battery specification information from the EVCC 21. For example, the battery specification information includes a battery type and/or temperature upper and lower limits in the format of character strings or codes. It is to be understood that the battery specification information has been stored in the BMS 22 of the EV 20, and the EVCC 21 of the EV 20 has communicated with the BMS 22. So, the EVCC 21 can read the battery specification information from the BMS 22 and transmit the battery specification information to the SECC 11. Or in another embodiment, the battery specification information can be stored in a memory of the EVCC 21. For example, according to the actual battery equipped on the EV, the corresponding battery specification information can be preset and stored in the memory of the EVCC 21 by the automobile manufacturer. So, the EVCC 21 can directly transmit the battery specification information in the memory of the EVCC 21 to the SECC 11. Besides, the battery specification information may further include one, more than one, or all of a maximum charge power, a maximum discharge power, a minimum charge power, a minimum discharge power, a maximum charge current, a maximum discharge current, a maximum voltage, and a minimum voltage.

STEP S2: The SECC 11 of the EVSE 10 sets and stores multiple threshold temperatures according to the battery specification information received from the EVCC 21. Two embodiments of STEP S2 of the present invention are described as follows.

### 1. First Embodiment of STEP S2

As mentioned above, the battery specification information may include the temperature upper and lower limits. In this embodiment, the battery specification information may include a discharging temperature lower limit T1, a charging temperature lower limit T2, a charging temperature upper limit T3, and a discharging temperature upper limit T4. The SECC 11 can directly set and store the foregoing T1, T2, T3, and T4 in the battery specification information received from the EVCC 21 as the multiple threshold temperatures. For example, the discharging temperature lower limit T1 is lower than the charging temperature lower limit T2, the charging temperature lower limit T2 is lower than the charging temperature upper limit T3, and the charging temperature upper limit T3 is lower than the discharging temperature upper limit T4, such that T1<T2<T3<T4.

### 2. Second Embodiment of STEP S2

The SECC 11 of the EVSE 10 has a lookup table. The lookup table may be stored in a memory of the SECC 11. The lookup table includes multiple prestored battery types and a discharging temperature lower limit T1, a charging temperature lower limit T2, a charging temperature upper limit T3, and a discharging temperature upper limit T4 that correspond to each prestored battery type. For example, T1<T2<T3<T4. As mentioned above, the battery specification information may include the information of the battery type. But when the temperature upper and lower limits are excluded from the battery specification information, the SECC 11 sets and stores the discharging temperature lower limit T1, the charging temperature lower limit T2, the charging temperature upper limit T3, and the discharging temperature upper limit T4 of the prestored battery type, which correspond to the battery type of the battery specification information, as the multiple threshold temperatures according to the foregoing lookup table.

For example, the lookup table stored in the SECC 11 can be expressed as follows:

| Prestored battery type | T2 | T3 | T1 | T4 |
|---|---|---|---|---|
| Valve Regulated | 0° C. | 50° C. | −20° C. | 60° C. |
| Lead-Acid (VRLA) | | | | |
| Li-ion | 0° C. | 45° C. | −20° C. | 55° C. |

When the battery specification information received by the SECC 11 is a character string including “VRLA” as the battery type, the SECC 11 can recognize the “VRLA” from the character string of the battery specification information to read the corresponding values including the discharging temperature lower limit T1 of −20° C., the charging temperature lower limit T2 of 0° C., the charging temperature upper limit T3 of 50° C., and the discharging temperature upper limit T4 of 60° C. from the foregoing lookup table. Then, the SECC 11 sets and stores the multiple threshold temperatures based on T1 (−20° C.), T2 (0° C.), T3 (50° C.), and T4 (60° C.).

In order to ensure the correctness of the battery specification information, as shown in FIG. 2, after the SECC 11 of the present invention receives the battery specification information in STEP S1, the SECC 11 can further determine whether the battery specification information is abnormal (as STEP S11) to check whether the information format of the battery specification information is abnormal basically. In an embodiment, the SECC 11 can determine whether the battery specification information includes an unrecognizable element. For example, the unrecognizable element may be a random code or an undefined string. In another embodiment, the SECC 11 can determine whether the temperature upper and lower limits of the battery specification information are abnormal. For example, when the SECC 11 determines that the charging temperature lower limit T2 is higher than the charging temperature upper limit T3, the information format of the battery specification information is abnormal. In STEP S11, when the SECC 11 determines the battery specification information is not abnormal, the SECC 11 enters STEP S2 to set and store the multiple threshold temperatures according to the battery specification information received from the EVCC 21, and can further transmit an information correct message to the EVCC 21, wherein the information correct message can include a response code “CORRECT” for the EVCC 21 to recognize the information correct message.

In contrast, in STEP S11, when the SECC 11 determines the battery specification information is abnormal, the SECC 11 can transmit an information error message to the EVCC 21, wherein the information error message can include a response code “ERROR” or “WARNING” for the EVCC 21 to recognize the information error message. For the above-mentioned embodiment of ISO 15118, when the EVCC 21 receives the response code “ERROR”, the entire communication between the EVCC 21 and the SECC 11 has to be interrupted. And then the EVCC 21 and the SECC 11 will be reconnected. So, the EVCC 21 can retransmit the battery specification information to the SECC 11 and then goes back to STEP S1. Besides, when the EVCC 21 receives the response code “WARNING”, the EVCC 21 can retransmit the battery specification information to the SECC 11 and then goes back to STEP S1.

STEP S3: The SECC 11 of the EVSE 10 receives a present battery temperature from the EVCC 21 during the charging or discharging process. Because the multiple threshold temperatures as the discharging temperature lower limit T1, the charging temperature lower limit T2, the charging temperature upper limit T3, and the discharging temperature upper limit T4 have been set and stored in the SECC 11 in STEP S2, the SECC 11 can perform the dynamic control mode to control the EVCC 21 to proceed to a charging or discharging process. During the processes of charging and discharging, the EVCC 21 reads a present battery temperature from the BMS 22 and transmits the present battery temperature to the SECC 11. The foregoing present battery temperature is a presently measured value of the battery's temperature of the EV 20. Hence, the SECC 11 of the EVSE 10 can receive the information of the present battery temperature of the EV 20 from the EVCC 21.

In addition, during the processes of charging and discharging, the EVCC 21 can read other battery operation information from the BMS 22. For example, the battery operation information from the BMS 22 may include one, more than one, or all of a maximum charge power, a maximum discharge power, a minimum charge power, a minimum discharge power, a maximum charge current, a maximum discharge current, a maximum voltage, and a minimum voltage.

STEP S4: The SECC 11 of the EVSE 10 determines whether the present battery temperature is higher or lower than the multiple threshold temperatures respectively, and accordingly modifies the charge schedule of the dynamic control mode, or can further generate an indication message and transmit the indication message to the EVCC 21. In an embodiment of the present invention, the SECC 11 determines whether the present battery temperature is higher or lower than the multiple threshold temperatures including the discharging temperature lower limit T1, the charging temperature lower limit T2, the charging temperature upper limit T3, and the discharging temperature upper limit T4 one by one, and further defines a response code according to the determination result. The SECC 11 can write the response code into the indication message and transmit the indication message to the EVCC 21. So, the indication message received by the EVCC 21 includes the foregoing response code. When the EVCC 21 receives the indication message, the EVCC 21 can perform an operation according to the response code included in the indication message.

STEP S5: The SECC 11 of the EVSE 10 may determine to terminate the charging or discharging process. When the SECC 11 determines to terminate the charging or discharging, the SECC 11 controls the EVSE 10 to stop charging the EV 20 or controls the EVSE 10 to stop receiving the electricity discharged from the EV 20. When the SECC 11 determines not to terminate the charging or discharging, the SECC 11 goes back to STEP S3. Please note that the conditions for the SECC 11 to or not to terminate the charging or discharging are not the key points of the present invention and are not described in detail herein. For example, the condition for the SECC 11 to or not to terminate the charging or discharging may be: the battery of the EV 20 is fully charged; or, the charging time is ended.

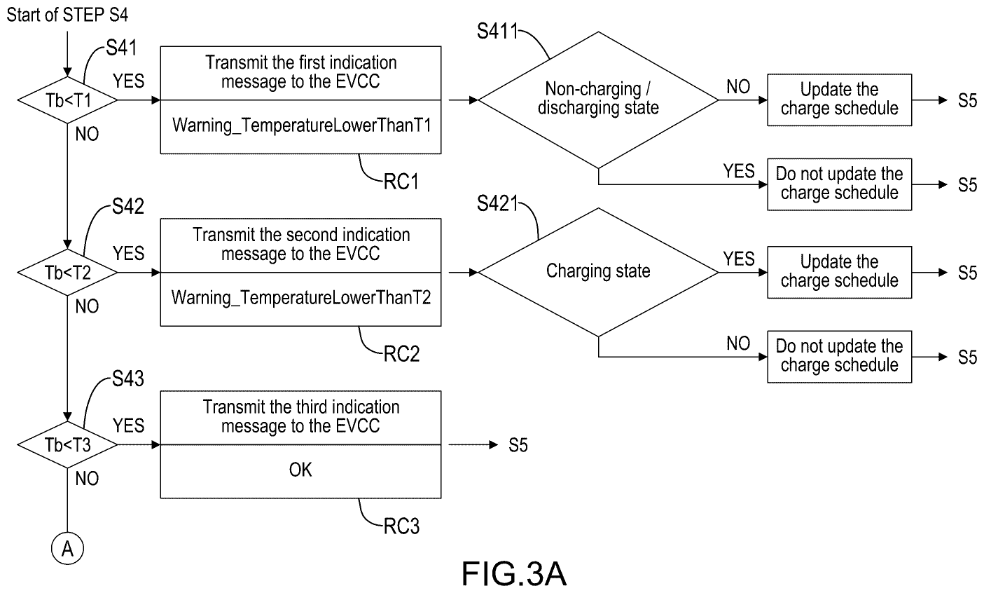

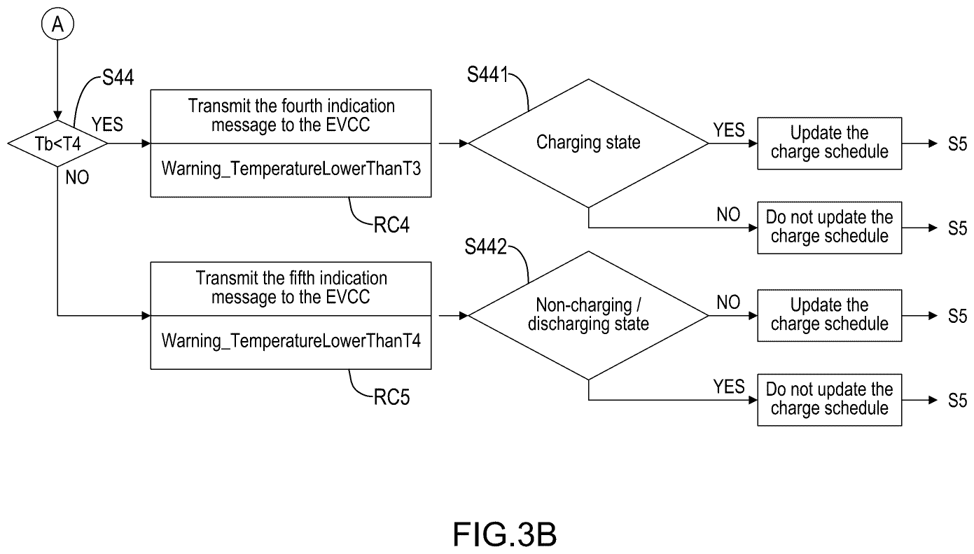

With reference to FIG. 3A and FIG. 3B, the embodiment of the foregoing STEP S4 includes:

STEP S41: The SECC 11 determines whether the present battery temperature Tb is lower than the discharging temperature lower limit T1.

STEP S42: The SECC 11 determines whether the present battery temperature Tb is lower than the charging temperature lower limit T2.

STEP S43: The SECC 11 determines whether the present battery temperature Tb is lower than the charging temperature upper limit T3.

STEP S44: The SECC 11 determines whether the present battery temperature Tb is lower than the discharging temperature upper limit T4.

Because T1<T2<T3<T4 as mentioned above, STEP S41 to S44 of the embodiment of the present invention is to compare the present battery temperature Tb with those limits from low to high (such as from the lowest T1 to the highest T4). The present invention is not limited to such embodiment.

When the determination result of STEP S41 is “YES”, which means the present battery temperature Tb is lower than the discharging temperature lower limit T1, the battery temperature of the EV 20 is too low. Then, the SECC 11 generates and transmits a first indication message to the EVCC 21, and determines whether the charge schedule of the dynamic control mode is in the non-charging/discharging state (STEP S411). When the determination result of STEP S411 is “YES”, which means the EV 20 is not discharging and is not being charged at the moment, the SECC 11 does not update the charge schedule of the dynamic control mode, such that the charge schedule can be retained. When the determination result of STEP S411 is “NO”, which means the EV 20 is discharging or is being charged at the moment, the SECC 11 updates the charge schedule of the dynamic control mode to control the EVSE 10 to stop charging the EV 20 or controls the EVSE 10 to stop receiving the electricity discharged from the EV 20. Hence, the EV 20 is prevented from discharging and being charged while the battery temperature is too low. Besides, the SECC 11 may write a first response code RC1 into the first indication message. The first response code RC1 can include a character string “Warning” or other format of codes to define the state of abnormal battery temperature for the EVCC 21 to recognize the first response code RC1 while receiving the first indication message. When the determination result of STEP S41 is “NO”, the present battery temperature Tb may be higher than or equal to the discharging temperature lower limit T1. Then, the SECC 11 enters STEP S42.

When the determination result of STEP S42 is “YES”, which means the present battery temperature Tb is not lower than the discharging temperature lower limit T1 and is lower than the charging temperature lower limit T2, the battery temperature of the EV 20 is still lower than normal. Then, the SECC 11 generates and transmits a second indication message to the EVCC 21, and determines whether the charge schedule of the dynamic control mode is in the charging state (STEP S421). When the determination result of STEP S421 is “NO”, which means the EV 20 is not being charged at the moment, the SECC 11 does not update the charge schedule of the dynamic control mode, such that the charge schedule can be retained. When the determination result of STEP S421 is “YES”, which means the EV 20 is being charged at the moment, the SECC 11 updates the charge schedule of the dynamic control mode to control the EVSE 10 to stop charging the EV 20. Hence, the EV 20 is prevented from being charged while the battery temperature is lower than normal. Besides, the SECC 11 may write a second response code RC2 into the second indication message. The second response code RC2 can include a character string “Warning” or other format of codes to define the state of abnormal battery temperature for the EVCC 21 to recognize the second response code RC2 while receiving the second indication message. When the determination result of STEP S42 is “NO”, the present battery temperature Tb may be higher than or equal to the charging temperature lower limit T2. Then, the SECC 11 enters STEP S43.

When the determination result of STEP S43 is “YES”, which means the present battery temperature Tb is not lower than the charging temperature lower limit T2 and is lower than the charging temperature upper limit T3, the battery temperature of the EV 20 is within a preset acceptable normal range. Then, the SECC 11 does not update the charge schedule of the dynamic control mode, such that the charge schedule is retained. Besides, the SECC 11 generates and transmits a third indication message to the EVCC 21, wherein the SECC 11 writes a third response code RC3 into the third indication message. The third response code RC3 can include a character string “OK” or other format of codes to define the state of normal battery temperature for the EVCC 21 to recognize the third response code RC3 while receiving the third indication message. When the determination result of STEP S43 is “NO”, the present battery temperature Tb may be higher than or equal to the charging temperature upper limit T3. Then, the SECC 11 enters STEP S44.

When the determination result of STEP S44 is “YES”, which means the present battery temperature Tb is higher than or equal to the charging temperature upper limit T3 and is lower than the discharging temperature lower limit T4, the battery temperature of the EV 20 is higher than normal. Then, the SECC 11 generates and transmits a fourth indication message to the EVCC 21, and determines whether the charge schedule of the dynamic control mode is in the charging state (STEP S441). When the determination result of STEP S441 is “NO”, which means the EV 20 is not being charged at the moment, the SECC 11 does not update the charge schedule of the dynamic control mode, such that the charge schedule can be retained. When the determination result of STEP S441 is “YES”, which means the EV 20 is being charged at the moment, the SECC 11 updates the charge schedule of the dynamic control mode to control the EVSE 10 to stop charging the EV 20. Hence, the EV 20 is prevented from being charged while the battery temperature is higher than normal. Besides, the SECC 11 may write a fourth response code RC4 into the fourth indication message. The fourth response code RC4 can include a character string “Warning” or other format of codes to define the state of abnormal battery temperature for the EVCC 21 to recognize the fourth response code RC4 while receiving the fourth indication message.

When the determination result of STEP S44 is “NO”, which means the present battery temperature Tb is higher than or equal to the discharging temperature upper limit T4, the battery temperature of the EV 20 is too high. Then, the SECC 11 generates and transmits a fifth indication message to the EVCC 21, and determines whether the charge schedule of the dynamic control mode is in the non-charging/discharging state (STEP S442). When the determination result of STEP S442 is “YES”, which means the EV 20 is not discharging and is not being charged at the moment, the SECC 11 does not update the charge schedule of the dynamic control mode, such that the charge schedule can be retained. When the determination result of STEP S442 is “NO”, which means the EV 20 is discharging or is being charged at the moment, the SECC 11 updates the charge schedule of the dynamic control mode to control the EVSE 10 to stop charging the EV 20 or controls the EVSE 10 to stop receiving the electricity discharged from the EV 20. Hence, the EV 20 is prevented from discharging and being charged while the battery temperature is too high. Besides, the SECC 11 may write a fifth response code RC5 into the fifth indication message. The fifth response code RC5 can include a character string “Warning” or other format of codes to define the state of abnormal battery temperature for the EVCC 21 to recognize the fifth response code RC5 while receiving the fifth indication message.

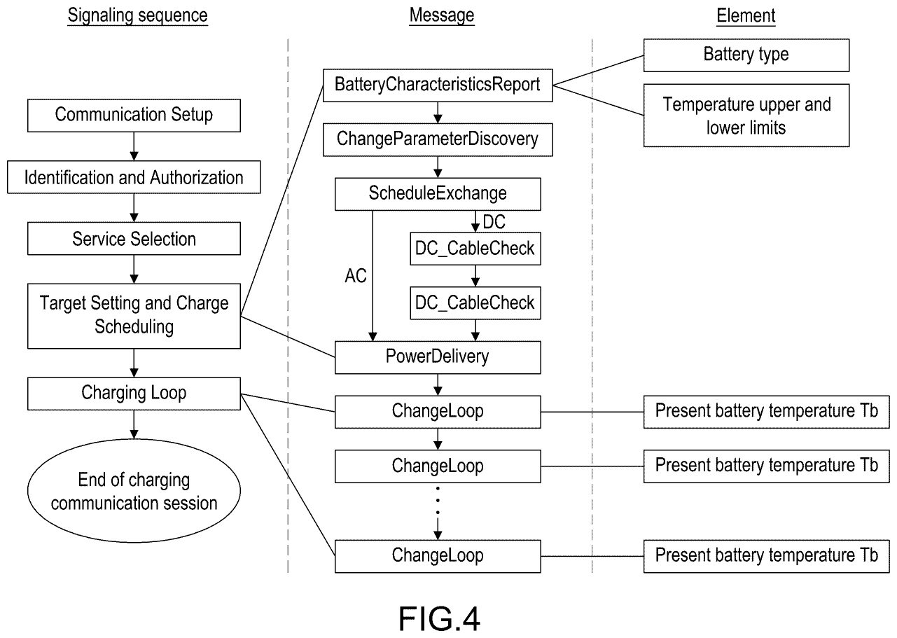

In the foregoing example of ISO 15118-20, the SECC 11 and the EVCC 21 may communicate with each other in the Application Layer of the Open Systems Intercommunication (OSI) seven-layer model. With reference to FIG. 4, the signaling sequence of the ISO 15118-20 protocol basically comprises the phases of “Communication Setup”, “Identification and Authorization”, “Service Selection”, “Target Setting and Charge Scheduling”, “Charging Loop”, and “End of charging communication session”. According to the message content of the “Target Setting and Charge Scheduling”, it is understandable that ISO 15118-20 involves charging/discharging operations of alternating current (AC) and direct current (DC) powers.

The SECC 11 and the EVCC 21 can transmit the messages to each other. The information included in the message is called “element”. The element may comprise at least one of numerals, English alphabets, and symbols. The SECC 11 and the EVCC 21 can write the elements into the messages, and can read and recognize the elements in the messages. The following description may be referred to FIGS. 4 and 5A to 5D, wherein FIGS. 5A to 5D depict the charging/discharging operations of DC power as example. The charging/discharging operations of AC power could be deduced.

In the ISO 15118-20 protocol, each message has a corresponding message name. For example, the communication in the phase “Communication Setup” of FIG. 5A includes a request message M1 named “SupportedAppProtocalReq” and a response message M2 named “SupportedAppProtocalRes”. The request message M1 is transmitted to the SECC 11 by the EVCC 21. The response message M2 is transmitted to the EVCC 21 by the SECC 11. So, the character strings of “Req” and “Res” in the message names may indicate the direction of the transmitted message. Among FIGS. 5A to 5D, the character string “Req/Res” included in some message names is a simplified expression to briefly depict the bidirectional communication between the SECC 11 and the EVCC 21 to transmit the messages.

STEP S1, STEP S11, and STEP S2 of the present invention can be performed in the phase “Target Setting and Charge Scheduling” of ISO 15118-20. The request message MB1 named “BatteryCharacteristicReportReq” in FIG. 5B corresponds to the battery specification information transmitted to the SECC 11 from the EVCC 21 in STEP S1. The elements in the battery specification information include the battery type BT, the charging temperature lower limit T2, the charging temperature upper limit T3, the discharging temperature lower limit T1, and the discharging temperature upper limit T4. The request message MB2 named “BatteryCharacteristicReportRes” in FIG. 5B corresponds to the information correct message transmitted to the EVCC 21 from the SECC 11 in STEP S11. The elements in the information correct message include the character string “OK” as the response code RC for the EVCC 21 to recognize.

STEP S3 and STEP S4 of the present invention can be performed in the phases “Charging Loop” and “Target Setting and Charge Scheduling” of ISO 15118-20. With reference to FIG. 5D, in STEP S3 of the present invention, the SECC 11 can obtain the foregoing present battery temperature Tb from the request message, named “DC_ChargeLoopReq”, transmitted by the EVCC 21 in the phase “Charging Loop”. Besides, the ISO 15118-20 protocol provides index values of power levels. The index value of the power level higher than 0 (Power level>0) corresponds to the charging state as mentioned in the embodiment of the present invention. The index value of the power level lower than 0 (Power level<0) corresponds to the discharging state as mentioned in the embodiment of the present invention. The index value of the power level equal to 0 (Power level=0) corresponds to the non-charging/discharging state as mentioned in the embodiment of the present invention. Therefore, the SECC 11 can determine the charge schedule of the dynamic control mode is in the charging state, the discharging state, or the non-charging/discharging state by reading the index value of the power level.

STEP S5 of the present invention can be performed in the phase “End of charging communication session” of ISO 15118-20.

In conclusion, the dynamic control mode is performed by the SECC 11 inside the EVSE 10 in the present invention. The SECC 11 obtains the battery-related information of the EV 20 via the EVCC 21 to set and store the temperature upper and lower limits applicable to the EV 20 for charging and discharging. Besides, during charging and discharging, the SECC 11 obtains the information of the present battery temperature Tb of the EV 20 via the EVCC 21. So, the SECC 11 can further determine whether the present battery temperature Tb is abnormal in the processes of charging and discharging. The EV 20 will be prevented from discharging and being charged if the present battery temperature Tb is determined as abnormal. Hence, some accidents, such as the damages to the battery of the EV 20 and to the equipment of the EVSE 10, will be avoided. And the safety for the processes of charging and discharging is increased.

In addition, the EV 20 includes the battery management system (BMS). Under the operation consistent with the forgoing ISO 15118-20 protocol as example, the method of the present invention will be directly performed as long as the communication is established between the SECC 11 and the EVCC 21. It is needless to equip additional battery temperature sensors and communication devices on the EV 20. Implementing the method of the present invention will have advantages of convenience, practicality, and decrease of additional cost.

What is claimed is:

1. A method applied to an electric vehicle supply equipment (EVSE) for monitoring an electric vehicle (EV) battery temperature, performed by a supply equipment communication controller (SECC) of the EVSE, wherein the SECC communicates with an electric vehicle communication controller (EVCC) of the EV and executes a dynamic control mode;
the method comprising:
step (a): receiving battery specification information from the EVCC by the SECC;
step (b): setting and storing multiple threshold temperatures according to the battery specification information by the SECC;
step (c): receiving a present battery temperature from the EVCC during charging or discharging by the SECC; and
step (d): determining, by the SECC, whether the present battery temperature is higher or lower than the threshold temperatures respectively, and accordingly modifying a charge schedule of the dynamic control mode by the SECC.

2. The method as claimed in claim 1, wherein in the step (a), when the SECC receives the battery specification information, the SECC further determines whether the battery specification information is abnormal;
if NO, the SECC sets and stores the multiple threshold temperatures according to the battery specification information;
if YES, the SECC transmits an information error message to the EVCC for the EVCC to retransmit the battery specification information and goes back to the step (a).

3. The method as claimed in claim 2, wherein in the step (a), the SECC determines whether the battery specification information is abnormal by determining whether the battery specification information includes an unrecognizable element.

4. The method as claimed in claim 2, wherein in the step (a), the SECC determines whether the battery specification information is abnormal by determining whether temperature upper limits and temperature lower limits included in the battery specification information are abnormal.

5. The method as claimed in claim 1, wherein
in the step (a), the battery specification information includes a charging temperature lower limit, a charging temperature upper limit, a discharging temperature lower limit, and a discharging temperature upper limit;
in the step (b), the SECC sets and stores the charging temperature lower limit, the charging temperature upper limit, the discharging temperature lower limit, and the discharging temperature upper limit as the multiple threshold temperatures.

6. The method as claimed in claim 1, wherein
the SECC has a lookup table including multiple prestored battery types and a charging temperature upper limit, a discharging temperature lower limit, and a discharging temperature upper limit that correspond to each prestored battery type;
in the step (a), the battery specification information includes a battery type;
in the step (b), based on the lookup table, the SECC sets and stores the charging temperature lower limit, the charging temperature upper limit, the discharging temperature lower limit, and the discharging temperature upper limit of the prestored battery type, which correspond to the battery type of the battery specification information, as the multiple threshold temperatures.

7. The method as claimed in claim 1, wherein
the SECC generates an indication message according to a determination result in the step (d) and transmits the indication message to the EVCC;
the indication message includes a response code; and
the SECC defines the response code according to the determination result.

8. The method as claimed in claim 5, wherein
the charge schedule of the dynamic control mode includes a charging state, a discharging state, and a non-charging/discharging state;
the discharging temperature lower limit is lower than the charging temperature lower limit; the charging temperature lower limit is lower than the charging temperature upper limit; and the charging temperature upper limit is lower than the discharging temperature upper limit;
in the step (d), when the SECC determines the present battery temperature is lower than the discharging temperature lower limit, the SECC further determines whether the charge schedule is in the non-charging/discharging state; if YES, the SECC does not update the charge schedule; if NO, the SECC updates the charge schedule.

9. The method as claimed in claim 6, wherein
the charge schedule of the dynamic control mode includes a charging state, a discharging state, and a non-charging/discharging state;
the discharging temperature lower limit is lower than the charging temperature lower limit; the charging temperature lower limit is lower than the charging temperature upper limit; and the charging temperature upper limit is lower than the discharging temperature upper limit;
in the step (d), when the SECC determines the present battery temperature is lower than the discharging temperature lower limit, the SECC further determines whether the charge schedule is the non-charging/discharging state; if YES, the SECC does not update the charge schedule; if NO, the SECC updates the charge schedule.

10. The method as claimed in claim 8, wherein in the step (d), when the SECC determines the present battery temperature is not lower than the discharging temperature lower limit and is lower than the charging temperature lower limit, the SECC further determines whether the charge schedule is in the charging state; if YES, the SECC updates the charge schedule; if NO, the SECC does not update the charge schedule.

11. The method as claimed in claim 9, wherein in the step (d), when the SECC determines the present battery temperature is not lower than the discharging temperature lower limit and is lower than the charging temperature lower limit, the SECC further determines whether the charge schedule is in the charging state; if YES, the SECC updates the charge schedule; if NO, the SECC does not update the charge schedule.

12. The method as claimed in claim 10, wherein in the step (d), when the SECC determines the present battery temperature is not lower than the charging temperature upper limit and is lower than the charging temperature upper limit, the SECC goes back to the step (c).

13. The method as claimed in claim 11, wherein in the step (d), when the SECC determines the present battery temperature is not lower than the charging temperature upper limit and is lower than the charging temperature upper limit, the SECC goes back to the step (c).

14. The method as claimed in claim 12, wherein in the step (d), when the SECC determines the present battery temperature is not lower than the charging temperature upper limit and is lower than the discharging temperature upper limit, the SECC further determines whether the charge schedule is in the charging state; if YES, the SECC updates the charge schedule; if NO, the SECC does not update the charge schedule.

15. The method as claimed in claim 13, wherein in the step (d), when the SECC determines the present battery temperature is not lower than the charging temperature upper limit and is lower than the discharging temperature upper limit, the SECC further determines whether the charge schedule is in the charging state; if YES, the SECC updates the charge schedule; if NO, the SECC does not update the charge schedule.

16. The method as claimed in claim 14, wherein in the step (d), when the SECC determines the present battery temperature is not lower than the discharging temperature upper limit, the SECC further determines whether the charge schedule is in the non-charging/discharging state; if YES, the SECC does not update the charge schedule; if NO, the SECC updates the charge schedule.

17. The method as claimed in claim 15, wherein in the step (d), when the SECC determines the present battery temperature is not lower than the discharging temperature upper limit, the SECC further determines whether the charge schedule is in the non-charging/discharging state; if YES, the SECC does not update the charge schedule; if NO, the SECC updates the charge schedule.
